(19) United States
(12) Patent Application Publication
(10) Pub. No.: US 2014/0095117 A1
(43) Pub. Date: Apr. 3, 2014

(54) THREE-DIMENSIONAL HUMAN-WORK PLANNING IN HAZARDOUS ENVIRONMENTS WITH CONTINUOUS FEEDBACK

(71) Applicant: SIEMENS PRODUCT LIFECYCLE MANAGEMENT SOFTWARE INC., Plano, TX (US)

(72) Inventors: Victor Michael Vainshtain, Herzliya (IL); Erica Claire Simmons, Dallas, TX (US); Noam Ribon, Ann Arbor, MI (US)

(73) Assignee: SIEMENS PRODUCT LIFECYCLE MANAGEMENT SOFTWARE INC., Plano, TX (US)

(21) Appl. No.: 13/629,823

(22) Filed: Sep. 28, 2012

(51) Int. Cl. G06F 17/50

(52) U.S. Cl. 703/1

(57) ABSTRACT

Product Lifecycle Management systems, methods, and mediums. A method includes generating a simulation of an environment within a predefined space. The method includes identifying one or more locations and a process for a human to perform a task in the predefined space based on the simulation in response to receiving a request to plan the process. The method includes identifying a time spent at the one or more locations for the task to be performed. The method includes identifying values for exposure to one or more hazardous sources at each of the one or more locations from a file. The method includes calculating an amount of exposure to the one or more hazardous sources in the simulation based on the one or more locations, the process the time spent and the identified functions for exposure from the file. Additionally, the method includes determining whether the amount exceeds a threshold value.

### TECHNICAL FIELD

The present disclosure is directed, in general, to computer-aided design, visualization, simulation, and manufacturing systems (“CAD systems”), product data management systems (“PDM”), product lifecycle management (“PLM”) systems, and similar systems, that manage data for products and other items (individually and collectively, product lifecycle management systems (“PLM”) systems).

### BACKGROUND OF THE DISCLOSURE

PLM systems can provide users with helpful and intuitive views of systems, objects, topologies, and other items.

As Low as Reasonably Achievable (ALARA) is a radiation safety principle that is used for minimizing radiation doses and releases of radioactive materials by employing all reasonable methods. ALARA is not only a sound safety principle, but it is a regulatory requirement for all radiation safety programs. In the United States, ALARA Title 10, Code of Federal Regulations, Part 835, governs Occupational Radiation Protection. Computing total dose in hazardous environments, like a nuclear plant, is very complex, in general because there is a wide spectrum of affecting factors, such as various types of radiation. Each of these factors has its own specific impact on human health. The current practice uses an “average” general hazardous field value and planning on paper, which might lead to large miscalculations in the evaluation of a real impact. In addition, the hazardous environment is not a constant and varies over time.

### SUMMARY OF THE DISCLOSURE

Various disclosed embodiments relate to systems and methods for three-dimensional human-work planning in hazardous environments with continuous feedback.

Various embodiments include PLM systems, methods, and mediums. A method includes generating a simulation of an environment within a building or predefined space. The method includes identifying one or more locations and a process for a human to perform a task in the building or predefined space or around the building's exterior in response to receiving a request to plan the process. The method includes identifying a time spent at specific locations or at points along the path an operator will be walking or traversing while performing a task. The method includes identifying values for exposure to one or more hazardous sources at each of the locations and points along the path from a file. The method includes calculating an estimate of an amount of exposure to the one or more hazardous sources for the human to perform the task in the simulation based on the locations, path, the time spent, the point where the exposure is calculated for, and the identified functions for exposure from the file. Additionally, the method includes determining whether the amount of exposure rate or accumulation exceeds a threshold value.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 illustrates a block diagram of a path planning system in which various embodiments of the present disclosure may be implemented;

FIG. 3 illustrates an example display of a user interface for a path planning simulation in accordance with an illustrative embodiment of the present disclosure;

FIG. 4 illustrates an example display of colorization of exposure in a three-dimensional simulation of a hazardous environment in accordance with an illustrative embodiment of the present disclosure;

FIG. 5 is an example display of colorization of exposure displayed in two-dimensions in the three-dimensional simulation of the hazardous environment displayed in the example display illustrated in FIG. 4;

FIG. 6 depicts a flowchart of a process for mapping hazardous environments in accordance with disclosed embodiments; and

FIG. 7 depicts a flowchart of a process for path planning in hazardous environments in accordance with disclosed embodiments.

### DETAILED DESCRIPTION

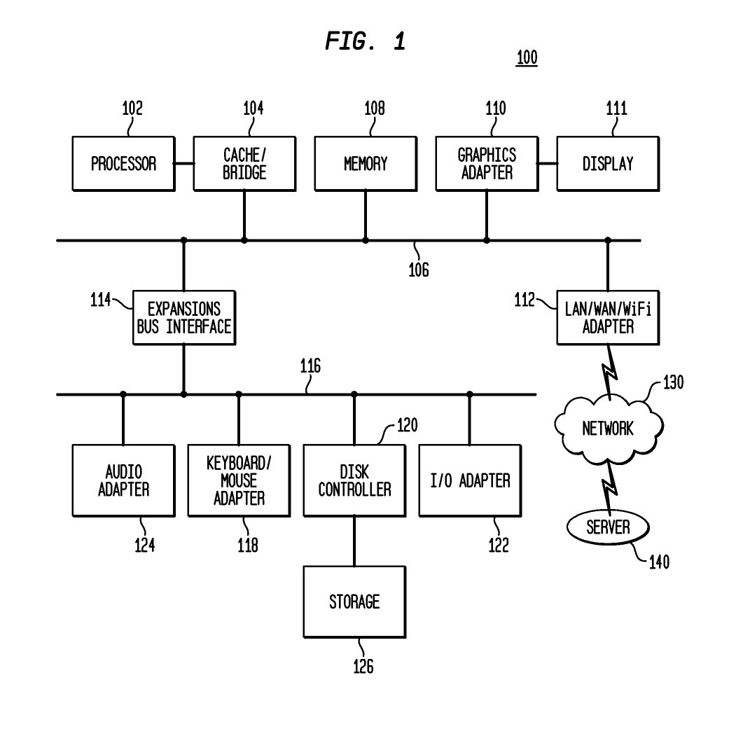

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments recognize that human path definition in a hazardous environment is a very complicated task because of many factors in existence. Additionally, hazardous environments are not stable and have variations. The human path definition in a hazardous environment is extremely important, because path definition is connected to health. Not planning the correct path can affect the health of the human by exposure to unnecessary hazardous materials.

Disclosed embodiments, described herein, provide calculation and simulation of the human path definitions and the health impact on the human from the hazardous environment from various hazardous sources, including radiation sources and chemical sources. Disclosed embodiments transform the spatial and temporal information about hazardous threats into an abstract adjustable model which allows iterative evaluation by partial and incremental feedback with precision improvement. Disclosed embodiments allow operators to project results into a real spatial environment and to plan safe behavior of humans in a hazardous environment. In multiple embodiments, the path can be planned without need for continuous calculation of the extent of the hazardous sources during the simulation, but rather rely on pre-calculated data, and the extrapolation thereof. In various embodiments, the present disclosure provides interactive computations of ALARA total dose rate for one or more workers and for one or more organs of each worker based on dynamic three-dimensional visual representations of the planned locations, postures, movement, the length of tasks, and the radiation sources.

In various embodiments, the present disclosure provides a method for decoupling the simulation of the total exposure and exposure rate, from the method of calculation of the exposure rate, which may be done independently or from within the application, per hazard type and exposure behavior. In various embodiments, the present disclosure provides a simulated environment with three-dimensional human avatar(s) and an abstract adjustable computing model that uses various information sources or types to model each active harmful factor in the environment. The present disclosure provides an analysis of hazard source on human organs and visual indication of dosage accumulation, including alerts for exceeding set human dose maximum(s) for each organ and dynamic interactive simulation and feedback whereby an operator is able to change the system's simulation parameters as needed to analyze various hazard scenarios using the three-dimensional avatar.

FIG. 1 depicts a block diagram of a data processing system 100 in which an embodiment can be implemented, for example as a PLM system particularly configured by software or otherwise to perform the processes as described herein, and in particular as each one of a plurality of interconnected and communicating systems as described herein. The data processing system 100 depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs), or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition to or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

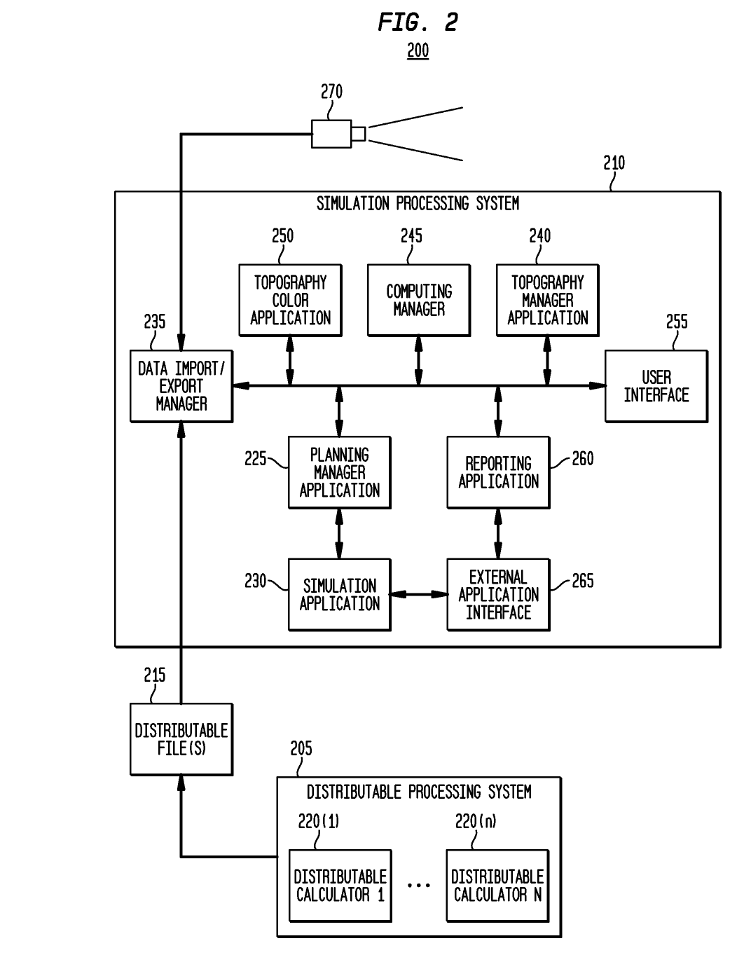

FIG. 2 illustrates a block diagram of a path planning system 200 in which various embodiments of the present disclosure may be implemented. The path planning system 200 includes distributable processing system 205 and simulation processing system 210. The distributable processing system 205 computes parameters of the hazardous environment in which humans may have to operate. The simulation processing system 210 generates a simulation of the environment for path planning and exposure calculation. The distributable processing system 205 and/or the simulation processing system 210 may be implemented in a data processing system, such as, for example, the data processing system 100 in FIG. 1.

The distributable processing system 205 maps out and calculates parameters associated with the hazardous environment in which humans operate. For example, the environment may be a building, factory, power plant, or some other type of predefined space where exposure to hazardous materials may exist. The hazardous materials may include hazards that humans can be exposed to without physical contact to the source of the hazardous material. For example, the hazardous materials may include radiation and chemical sources. The distributable processing system 205 calculates dimensions of objects within the environment to map out the working environment.

The distributable processing system 205 also identifies and calculates properties of the hazardous sources within the working environment. For example, the distributable processing system 205 calculates algorithms or functions for dosage rate of exposure to the hazardous material as a function of one or more variables, such as distance from the hazardous source, position relative to the hazardous source, length of exposure time to the hazardous source, and/or a type of hazardous material (e.g., chemical, neutron radiation, gamma radiation, beta radiation, etc.). The distributable processing system 205 also combines or merges the results of computing the hazardous environment into one or more distributable file(s) 215. In various embodiments, the distributable file(s) 215 may include values calculated on different individual elements and/or properties of the hazardous sources. For example, the distributable processing system 205 may identify the chemical or elemental composition of a hazardous source as well as wavelengths for radiation associated with each individual chemical element. This information may be calculated and included in the distributable file(s) 215.

The distributable processing system 205 provides accuracy and efficiency in work planning The distributable processing system 205 includes multiple distributable calculators 220(1)-(n), which can perform mapping and computing operations in parallel. For example, one or more distributable calculators perform parallel computing on hazardous environments with variants on some machines. At the same time, other distributable calculators can work with completed hazard environment definitions to merge definitions together.

The distributable processing system 205 creates an overall environment from the distributable calculators 220(1)-(n) and can account for variations in the different environment definitions. The distributable processing system 205 produces a standardized output in the form of the distributable file(s) 215 that can be utilized by components of the simulation processing system 210. The distributable processing system 205 may have a user interface to allow a user to monitor and control the definitions of the parameters of the environment and the distributable calculators 220(1)-(n).

In addition to or instead of the computation and mapping of the environment by the distributable processing system 205, various embodiments of the present disclosure may obtain properties of the hazardous sources within the working environment and locations of objects within the working environment from other sources. For example, the path planning system 200 may obtain information from building plans, contractors, machine specifications, and other sources of information about hazards and objects in the working environment. The path planning system 200 combines and merges data from these information sources into a standardized data format in the distributable file(s) 215. Using a standardized data format for the distributable file(s) 215, the path planning system 200 is able to update and modify the known information about the environment as the information becomes available to improve prediction results.

Within the distributable file(s) 215 there may be two file types: an environment description type and a hazard distribution type. The environment-description file type defines properties of the hazard sources, parameters of protective objects, and situations in the environment. This file type may be used as an input for computing hazard distribution in the environment. The hazard-distribution file type defines parameters of the hazards based on coordinates in three-dimensional space. This file type is the output type for components within the simulation processing system 210. This file type configuration supports collection of a wide range of hazard information and provides a wide spectrum of merge operations that may be used.

The simulation processing system 210 generates a simulation of the environment calculated by the distributable processing system 205 for path planning in the environment. For example, the simulation processing system 210 includes a planning manager application 225 and a simulation application 230. The planning manager application 225 plans paths for accomplishment of a task within a simulation of the environment generated by the simulation application 230. The planning manager application 225 manages the overall interaction of the various components within the simulation processing system 210. The simulation application 230 generates the simulation of the environment and the paths to perform tasks by one or more humans, depending on whether more than one human is needed to perform a task.

While the present disclosure generally uses the term ‘path’ the use of the path is for the purpose of explanation and not intended as a limitation on the various embodiments. For example, while the term ‘path’, in general, can be interpreted as an collection of points defining a trajectory an object or an avatar follows traversing between a start and end points in space, the term ‘path” can be construed in this disclosure to mean a single location, or a plurality of non-related locations, or a combination of all of the above. Similarly, ‘planning a path’, ‘path planning’ or related terms can be construed as planning for a single location, a plurality of non-related locations, a path in its general meaning or a combination of the above.

In various embodiments, the simulation processing system 210 generates the simulation of the environment without needing to calculate values for dose rate. For example, the simulation processing system 210 identifies the dose rate for points in the environment from a precompiled file that already includes the information for dose rate for points in the environment. For example, the information for dose rate for points in the environment can be obtained from the distributable file(s) 215 with the information obtained from multiple sources including, for example, calculated by the distributable processing system 205 and/or merged into the distributable file(s) 215 from building plans, contractors, and machine specifications. Calculating all the dose rate values at runtime of the simulation would be very complicated and slow. Accordingly, the simulation processing system 210 identifies the dose rate values from the distributable file(s) 215 and/or merges in information from other sources to generate the simulation of the environment. The planning manager application 225 is able to calculate multiple different paths and associated dosage rate and accumulation for the human on the path from the identified points for the dose rate that were previously calculated. As a result, during the simulation of the environment and the planning of the path, the simulation processing system 210 is able to quickly provide dosage rate and accumulation for different paths.

Data import/export manager 235 controls the input and output of standard file flows to and from the distributable processing system 205. In addition, the data import/export manager 235 provides connections to other systems or information sources, such as, for example, monitoring systems, measurement systems, and processing systems. The standard formatting for the file(s) 215 allows the integration of the results from the distributable processing system 205 to the simulation processing system 210 as well as other to other complex systems with a simple interface.

The topography manager application 240 defines the topography of the workspace within the environment. For example, the topography manager application 240 identifies human path walkways, selected space or full space topography information under control of the planning manager application 225 with hazard, and protective objects parameters and situations from the simulation application 230. On the information about the environment from the distributable processing system 205, the topography manager application 240 distributes the environment-description type files to computing manager 245 for computation of the environment.

The topography color application 250 generates space colorization according to the hazard-distribution type file information. The topography color application 250 generates colorization of different exposure rates at different points in the environment. This colorization provides a path planner with robust hazard distribution information and a visualization of possibilities for path creation. The user interface 255 generates a display of the simulation of the environment including the colorization of the hazards and the objects in the environment. The user interface 255 provides an interface for users to view results information calculated by the simulation application 230 and to input parameters, such as tasks to be performed, number of humans to be used, and paths to be taken in the environment. The information displayed in the user interface 255 may include results on an effect of the hazard exposure to the human which can be displayed in real time in the simulation.

The reporting application 260 generates reports on the simulation. For example, the reporting application 260 may generate reports on paths to be taken to perform tasks and exposure rates for task performance. Such reports may be useful or required in maintaining health and safety standards. These reports can be exported and saved, for example, to product data management systems. The external application interface 265 provides an interface for integrating data from the simulation processing system 210 to another system. For example, components of the simulation processing system 210 may be integrated to sit on top of other management systems, such as building automation systems or product lifecycle management systems.

In various embodiments, the planning manager application 225 receives user input for a task to be performed. The planning manager application 225 indentifies one or more paths that a human could take to perform the task. For example, the topography manager application 240 may locate one or more objects in a building that is required for a human to come into contact with to complete the task and multiple paths from one or more entry points to the one or more objects and back out to one or more exit points. Additionally, for a given path and task, the planning manager application 225 calculates an amount of time that the human is present at various points or coordinates along the path. For example, the human may walk down a hallway at a certain speed, stop at an object for a certain period of time to complete the task, and then walk back through the hallway. Based on the exposure rates for each point and length of time the human is at each point, the simulation application 230 can supply dosage rates and dosage accumulation for exposure to hazardous materials during completion of the task.

For example, in various embodiments, the planning manager application 225 can supply coordinates extracted from selected areas along the path. This process can be repeated with different areas of a working space along the path with different dots density representative of exposure rate. These coordinates and dot density may be generated in a cylindrical (or spherical) coordinate system. The coordinates and dot density represent a topographical part of hazard-distribution type file where the dots are associated with hazard values. The planning manager application 225 can generate the values based on the functions or algorithms for exposure rate from the distributable file(s) 215.

In various embodiments, the planning manager application 225 can implement “on the fly” planning For example, the planning manager application 225 can obtain the exposure values for the simulation application 230 and directly compute exposure values of “on the fly” conditions, such as the path, hazard sources, or protective objects are changed. The time needed to compute this hazard is extra low, because the simulation processing system 210 calculates the path values on the base of the cached, pre-computed hazard-distribution type file containment without needing to generate a new simulation for the changed conditions. For example, because the hazard-distribution type file contains all of the space dots' definition for the hazard-distribution, changed conditions (other than the number of humans) do not affect the information used to calculate the hazard-distribution.

Possible advantages that the path planning system 200 include: generation of an abstract adjustable model (or mirror) of coordinates that can be used and modified by the components within the simulation processing system 210; generation of dynamic space colorization according to, for example, hazard level; generation of precompiled hazard distribution to reduce computation requirements during a simulation; and generation of a standardized data exchange that is open for adding, exchanging, or excluding components and reusable by various system components.

In various embodiments, the simulation processing system 210 can identify exposure to individual parts of the body in addition to averages for the whole body. For example, the simulation processing system 210 generates an avatar of a human performing the task on the path and can, for specific parts of the avatar (e.g., parts representative of limbs or vital organs), compute the exposure rate and exposure amounts for the task. In some embodiments, the simulation processing system 210 accesses a library of human movement associated with performing the task to determine individual body part positions at various points during task performance.

In other embodiments, the simulation processing system 210 receives inputs from a motion capture device 270 to determine individual body part positions at various points during task performance. The motion capture device 270 may be a sensor or camera (e.g., a Kenect™ motion capture device) for capturing data associated with detected positions of a human, for example, actually performing the task. In this manner, the simulation processing system 210 can tailor simulations to the human that may be performing the task in the manner that the human would actually perform the task. This use of motion capture data allows the simulation processing system 210 to improve accuracy of not only total exposure amounts but also exposure to specific body parts as different humans have different sizes and may perform the same task in different manners.

The description of the path planning system 200 in FIG. 2 is intended as an illustrative example and not as an architectural limitation to the various embodiments which may be implemented. For example, in various embodiments, the path planning system 200 may include additional components or may not include some of the components depicted.

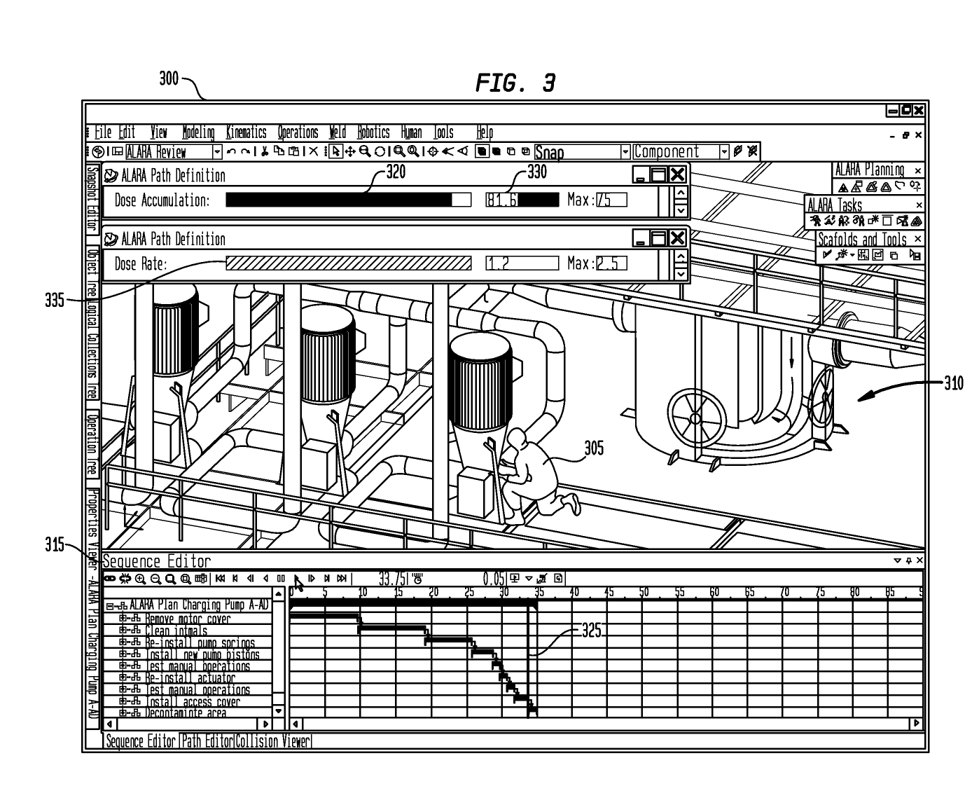

FIG. 3 illustrates an example display of a user interface 300 for a path planning simulation in accordance with an illustrative embodiment of the present disclosure. For example, the user interface 300 is an example of one embodiment of the user interface 255 illustrated in FIG. 2. In this illustrative example, user interface 300 provides a display of a simulation of an avatar 305 performing a task in a three-dimensional environment 310. The user interface 300 includes a sequence editor 315 that allows an operator to input a task or tasks. In this depicted example, the tasks include tasks related to a charging pump, such as installing an access cover. Based on the location of the values, and the strainer, and an expected amount of time to perform the tasks, the planning manager application 225 identifies the path or paths that can be taken and the amount of time that performing the tasks will take. The user interface 300 also displays dose rate 335 and accumulation information 320 based on a current time 325 in the simulation of the performance of the task. The user interface 300 displays alerts 330 if the dose rate or the total dose accumulation exceeds threshold levels.

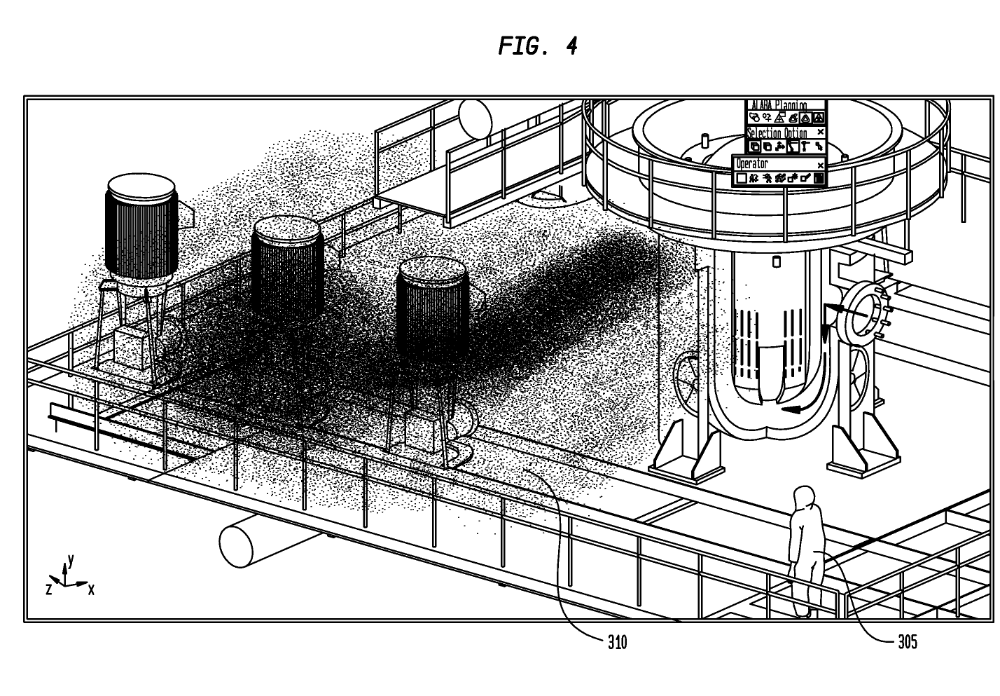

FIG. 4 illustrates an example display of colorization of exposure in a three-dimensional simulation of a hazardous environment in accordance with an illustrative embodiment of the present disclosure. For example, the colorization illustrated in FIG. 4 is an example of colorization that the topography color application 250 may generate to be included in a simulation. In this example, the darker shaded areas depict higher concentration areas of exposure. Though not illustrated, the areas may be colored accordingly. For example, red areas may indicate high exposure areas with green areas indicating low or no exposure areas. Using the colorization, an operator is provided with a visual indication of high exposure areas. This illustration may allow the operator to plan paths appropriately.

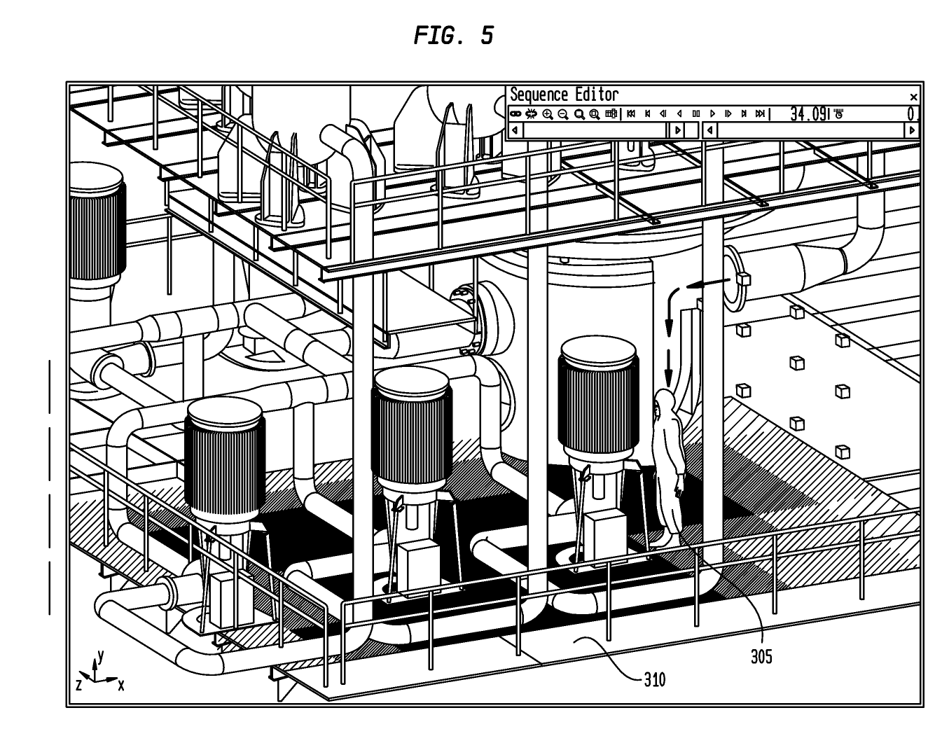

FIG. 5 is an example display of colorization of exposure displayed in two-dimensions in the three-dimensional simulation of the hazardous environment displayed in the example display illustrated in FIG. 4. As depicted, the colorization illustrates exposure rates for different areas in the environment. Based on the display, an operator is provided with a visual indication of exposure rates in different areas to plan paths accordingly.

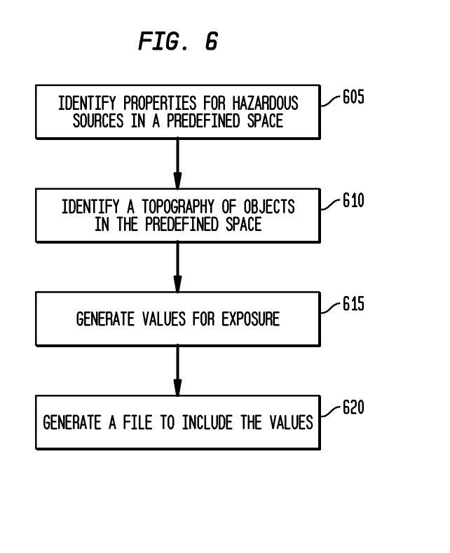

FIG. 6 depicts a flowchart of a process for mapping hazardous environments in accordance with disclosed embodiments. This process can be performed, for example, by one or more PLM data processing systems configured to perform acts described below, referred to in the singular as “the system.” The process can be implemented by executable instructions stored in a non-transitory computer-readable medium that cause one or more PLM data processing systems to perform such a process. The process illustrated in FIG. 6 is an example of a process that may be performed by the distributable processing system 205 to map hazardous environments.

The process begins by the system identifying properties for hazardous sources in a predefined space (step 605). For example, as part of this step, the system may identify properties, such as types of hazardous sources, locations of the hazardous sources, and/or functions for exposure amount based on exposure time and proximity.

The system then identifies a topography of objects in the predefined space (step 610). For example, as part of this step, the system may identify locations of objects that reflect measured values of hazardous sources, their recorded values, objects that have protective characteristics, and may alter the exposure otherwise expected in their vicinity.

The system then generates values for exposure (step 615). For example, as part of this step, the system may generate the values for exposure rate at a plurality of points in three-dimensional space in the predefined space based on the properties for the hazardous sources and shielding factors for objects within the predefined space.

The system then generates a file to include the values (step 620). For example, as part of this step, the system may generate the file to include the locations of the objects in the predefined space and their values for exposure at the points in the predefined space. The system may include these values in the distributable file(s) 215 as described with regard to FIG. 2 above. The simulation processing system 210 may then be able to quickly identify amounts of exposure for tasks performed along a planned path simulated, based on the files generated.

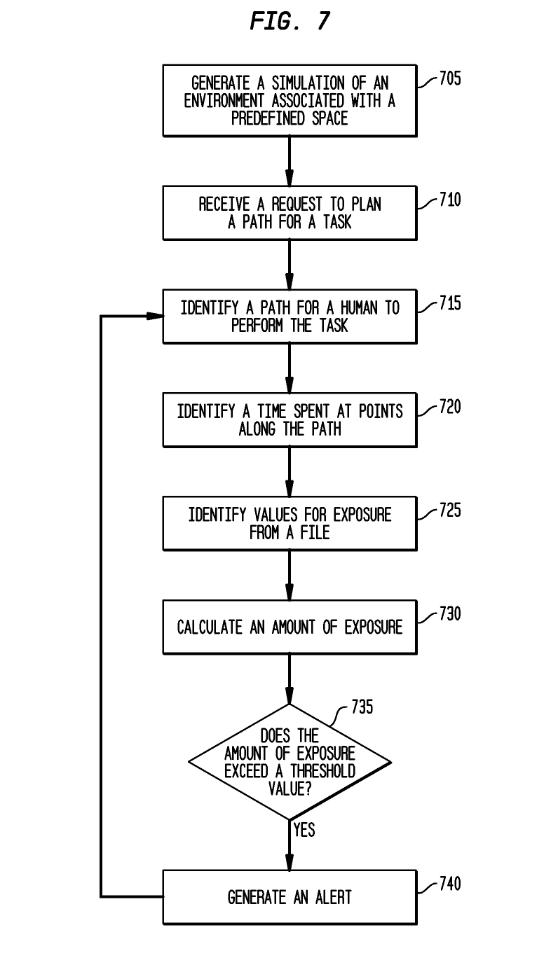

FIG. 7 depicts a flowchart of a process for path planning in hazardous environments in accordance with disclosed embodiments. This process can be performed, for example, by one or more PLM data processing systems configured to perform acts described below, referred to in the singular as “the system.” The process can be implemented by executable instructions stored in a non-transitory computer-readable medium that cause one or more PLM data processing systems to perform such a process. The process illustrated in FIG. 7 is an example of a process that may be performed by the simulation processing system 210 to plan paths in hazardous environments.

The process begins by the system generating a simulation of an environment within a predefined space (step 705). For example, as part of this step, the system may generate the simulation using files containing values for exposure and locations of objects mapped out in the environment. The simulation is a simulation of the environment within a predefined space. The simulation may include a colorization of exposure displayed in two or three dimensions in the predefined space. For example, the generation of the simulation may occur in response to a request for an operator to plan a path and process for a human to perform a task in the environment.

The system then receives a request to plan a path for a task (step 710). “Receiving,” as used herein, can include loading from storage, receiving from another device or process, or receiving through an interaction with a user. The system then identifies a path for a human to perform the task (step 715). For example, as part of this step, the system may identify objects associated with the task and identify a path to and from the objects for the human or humans to perform the task.

The system then identifies a time spent at points along the path (step 720). For example, as part of this step, the system may calculate the time based on an amount of time to arrive at a location, perform one or more tasks, and return from the location. The points along the path may include points in three-dimensional space for body parts of the human. For example, as part of this step, the system may receive motion capture data associated with a human performing the task from a motion capture device and identify the points in three-dimensional space for the body parts of the human from the motion capture data.

The system identifies values for exposure from a file (step 725). For example, as part of this step, the system may identify the values for exposure from one or more hazardous sources in the predefined space for each point along the path. The system may identify these values from a file containing previously calculated values for dose rate at points in the environment, for example, the distributable file(s) 215 in FIG. 2. The values can include values for points or coordinates in three-dimensional space.

The system then calculates an amount of exposure (step 730). For example, as part of this step, the system may calculate the amount of exposure to the one or more hazardous sources based on the path, the time spent, and the identified values for exposure. The system may also calculate amounts of exposure to individual vital organs of the human. The amount of exposure may be a rate of exposure or a total accumulation of exposure.

The system then determines whether the amount of exposure exceeds a threshold value (step 735). For example, as part of this step, the system may determine whether the amount of exposure exceeds a threshold value for each of the vital organs. The system may also determine whether the rate of exposure exceeds a threshold value for exposure rate and/or whether a total accumulation of exposure exceeds a threshold value for total exposure accumulation.

If the amount of exposure exceeds a threshold value, the system generates an alert (step 740). For example, the alert may be a message displaying that the exposure amount exceeded the threshold. The system may then return to step 715 to iteratively process through different paths to find a path with an as low as reasonably achievable amount of exposure. For example, the system can process different paths' exposure quickly within the same simulation due to the exposure values generated in advance. The system merely decides which of the pre-generated values to include in the path analysis to quickly calculate the amount of exposure for different paths.

Disclosed embodiments provide the ability to plan paths in hazardous environments. Disclosed embodiments provide a dynamic interactive simulation and feedback whereby an operator is able to change the systems' simulation parameters as needed to analyze various hazard scenarios. Disclosed embodiments are able to quickly calculate the total exposure or hazard for a human for ALARA planning using an interactive application. This is particularly important, because disclosed embodiments use the applications in the PLM system to manage the configuration of data inputs. This makes the simulation of the information more expansive, accurate, and faster than previous computing methods.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

1. A method performed by a product lifecycle management (PLM) data processing system, the method comprising:
generating a simulation of an environment within a predefined space;
identifying one or more locations and a process for a human to perform a task in the predefined space based on the simulation in response to receiving a request to plan the process;
identifying a time spent at the one or more locations for the task to be performed;
identifying, by the PLM data processing system, values for exposure to one or more hazardous sources at each of the one or more locations from a file;
calculating an estimate of an amount of exposure to the one or more hazardous sources for the human to perform the task in the simulation based on the one or more locations, the process, the time spent, and the identified values for exposure from the file;
determining whether the amount of exposure exceeds a threshold value; and
storing the amount of exposure.

2. The method of claim 1, wherein the one or more locations include points along a path for the task to be performed, wherein the points are in three-dimensional space for body parts of the human, and wherein the identified values include values for the points in three-dimensional space.

3. The method of claim 2, wherein calculating the amount of exposure comprises calculating exposure to vital organs of the human and
wherein determining whether the amount of exposure exceeds the threshold value comprises determining whether the amount of exposure exceeds a threshold value for each of the vital organs.

4. The method of claim 2, wherein identifying the time spent at the one or more locations for the task to be performed comprises:
receiving motion capture data associated with a human performing the task from a motion capture device; and
identifying the points in three-dimensional space for the body parts of the human from the motion capture data.

5. The method of claim 1 further comprising:
identifying properties for a plurality of hazardous sources in the predefined space, wherein the properties for the plurality of hazardous sources include properties of elements in at least one of the hazardous sources;
identifying a topography of objects in the predefined space;
generating values for exposure to the hazardous sources at a plurality of points in three-dimensional space in the predefined space based on the properties for the hazardous sources and shielding factors for objects within the predefined space; and
generating the file to include the values for exposure rate exposure for use in generating path planning simulations.

6. The method of claim 5, wherein generating the simulation of the environment in the predefined space comprises:
generating a display comprising a color intensity mapping of different exposure levels at different positions within the predefined space based on the properties for the hazardous sources and the shielding factors.

7. The method of claim 1 further comprising:
in response to determining that the amount of exposure exceeds the threshold value, generating an alert; identifying a different location for performance of the task in the simulation of the environment within the predefined space; and calculating the amount of exposure for the different location.

8. The method of claim 1 further comprising:
calculating an amount of exposure for a plurality of paths in the simulation of the environment within the predefined space to identify a path to complete the task with as low as reasonably achievable amount of exposure.

9. A product lifecycle management (PLM) data processing system comprising:
a processor; and
an accessible memory, the data processing system particularly configured to:
generate a simulation of an environment within a predefined space;
identify one or more locations and a process for a human to perform a task in the predefined space based on the simulation in response to receiving a request to plan and the process;
identify a time spent at points along the path for the task to be performed;
identify, using the processor, values for exposure to one or more hazardous sources at each of the points along the path from a file;
calculate an estimate of an amount of exposure to the one or more hazardous sources for the human to perform the task in the simulation based on the one or more locations, the process the time spent and the identified values for exposure from the file;
determine whether the amount of exposure exceeds a threshold value; and
store the amount of exposure.

10. The PLM data processing system of claim 9, wherein the one or more locations include points along a path for the task to be performed, wherein the points are in three-dimensional space for body parts of the human and wherein the identified values include values for the points in three-dimensional space.

11. The PLM data processing system of claim 10, wherein:
to calculate the amount of exposure the data processing system is further configured to calculate exposure to vital organs of the human, and
to determine whether the amount of exposure exceeds the threshold value, the data processing system is further configured to determine whether the amount of exposure exceeds a threshold value for each of the vital organs.

12. The PLM data processing system of claim 10, wherein to identify the time spent at the at the one or more locations for the task to be performed, the data processing system is further configured to:
receive motion capture data associated with a human performing the task from a motion capture device; and
identify the points in three-dimensional space for the body parts of the human from the motion capture data.

13. The PLM data processing system of claim 9, wherein the data processing system is further configured to:
identify properties for a plurality of hazardous sources in the predefined space, wherein the properties for the plurality of hazardous sources include properties of elements in at least one of the hazardous sources;
identify a topography of objects in the predefined space;
generate values for exposure to the hazardous sources at a plurality of points in three-dimensional space in the predefined space based on the properties for the hazardous sources and shielding factors for objects within the predefined space; and
generate the file to include the values for exposure rate for use in generating path planning simulations.

14. The PLM data processing system of claim 13, wherein the data processing system is further configured to, in response to determining that the amount of exposure exceeds the threshold value:
generate an alert;
identifying a different location for performance of the task in the simulation of the environment within the predefined space; and
calculate the amount of exposure for the different location.

15. A non-transitory computer-readable medium encoded with executable instructions that, when executed, cause one or more product lifecycle management (PLM) data processing systems to:
generate a simulation of an environment within a predefined space;
identify one or more locations and a process for a human to perform a task in the predefined space based on the simulation in response to receiving a request to plan the process;
identify a time spent at the one or more locations for the task to be performed;
identify values for exposure to one or more hazardous sources at each of the one or more locations from a file;
calculate an estimate of an amount of exposure to the one or more hazardous sources for the human to perform the task in the simulation based on the one or more locations, the process the time spent and the identified values for exposure from the file;
determine whether the amount of exposure exceeds a threshold value; and
store the amount of exposure.

16. The computer-readable medium of claim 15, wherein the one or more locations include points along a path for the task to be performed, wherein the points are in three-dimensional space for body parts of the human and wherein the identified values include values for the points in three-dimensional space.

17. The computer-readable medium of claim 16, wherein:
the instructions that cause the PLM data processing system to calculate the amount of exposure comprise instructions that cause the PLM data processing system to calculate exposure to vital organs of the human, and
the instructions that cause the PLM data processing system to determine whether the amount of exposure exceeds the threshold value comprise instructions that cause the PLM data processing system to determine whether the amount of exposure exceeds a threshold value for each of the vital organs.

18. The computer-readable medium of claim 16, wherein the instructions that cause the PLM data processing system to identify the time spent at the one or more locations along the path for the task to be performed comprise instructions that cause the PLM data processing system to:
receive motion capture data associated with a human performing the task from a motion capture device; and
identify the points in three-dimensional space for the body parts of the human from the motion capture data.

19. The computer-readable medium of claim 15 further comprising instructions that cause the PLM data processing system to:
identify properties for a plurality of hazardous sources in the predefined space, wherein the properties for the plurality of hazardous sources include properties of elements in at least one of the hazardous sources;
identify a topography of objects in the predefined space;
generate values for exposure to the hazardous sources at a plurality of points in three-dimensional space in the predefined space based on the properties for the hazardous sources and shielding factors for objects within the predefined space; and
generate the file to include the functions for exposure rate for use in generating path planning simulations.

20. The computer-readable medium of claim 19 further comprising instructions that cause the PLM data processing system to, in response to determining that the amount of exposure exceeds the threshold value:
generate an alert;
identifying a different location for performance of the task in the simulation of the environment within the predefined space; and
calculate the amount of exposure for the different location.
